(19) United States
(12) Patent Application Publication
(10) Pub. No.: US 2014/0122056 A1
(43) Pub. Date: May 1, 2014

(54) CHATBOT SYSTEM AND METHOD WITH ENHANCED USER COMMUNICATION

(71) Applicant: Xiaojiang Duan, Chaoyang District (CN)

(72) Inventor: Xiaojiang Duan, Chaoyang District (CN)

(21) Appl. No.: 13/661,042

(22) Filed: Oct. 26, 2012

(51) Int. Cl. G06F 17/27

(52) U.S. Cl. 704/9

(57) ABSTRACT

A chatbot system and method with enhanced user communication. A termination mark signifies that a chatbot input message sentence is complete. The chatbot system responds to the input message before a plurality of sentences are entered along with the input message sentence.

### CROSS-REFERENCE TO RELATED APPLICATIONS

This application is related to the following U.S. non-provisional patent applications: U.S. patent application Ser. No. ______, entitled “User-Aided Learning Chatbot System and Method” filed herewith (Attorney Docket No. ACOSYS.002US); U.S. patent application Ser. No. ______, entitled “Chatbot System and Method with Contextual Input and Output Messages” filed herewith (Attorney Docket No. ACOSYS.003US); U.S. patent application Ser. No. ______, entitled “Chatbot System and Method with Interactive Chat Log” filed herewith (Attorney Docket No. ACOSYS.005US); U.S. patent application Ser. No. ______, entitled “Chabot System and Method Having Auto-Select Input Message with Quality Response” filed herewith (Attorney Docket No. ACOSYS.006US); all of which are hereby incorporated by reference in their entirety as if fully set forth in the present invention for all purposes.

### COMPUTER PROGRAM LISTING APPENDIX

A computer program listing appendix is provided via EFS with this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to chatbot systems and methods and more specifically to chatbot systems and methods for enhancing user input communication.

Chatbot computer programs are designed to simulate intelligent conversation with one or more human users via auditory or textual methods. Chatbots are often integrated into interactive dialogs for various practical purposes such as personalized service, or information acquisition.

An interactive dialog between a user and the chatbot is referred to as a chat session. Users can receive answers to inquiries and receive information from the chatbot during the chat session. The answers that the user receives from the chatbot are often preprogrammed into the chatbot.

A user wishing to receive a response can type a desired input message. Sometimes, the input message is a single input message. At other times, the input message might have multiple sentences. Further yet, the user may copy and paste multiple sentences to form a single input message.

In response, the chatbot can often identify the single input message and can thereafter respond with an appropriate output message. As for input messages with multiple sentences, the chatbot can reply to each sentence in the input message and assemble the replies as an output message. The output message is often incoherent or unsatisfactory as it includes responses that are obvious, inconsistent or conflicting.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a chatbot system and method with enhanced response can be found in exemplary embodiments of the present invention.

In a first embodiment, a user and the chatbot system interact during a chat session. The user enters an input message such as question, comment, etc. The form of the input message might be a sentence including a terminating mark. A terminating mark might be punctuation that indentifies a complete sentence. As an example, a terminating mark might be a question mark “?”. For western languages including English, the terminating mark might be a question mark following by a space “?”. The terminating mark is predetermined and is one of a plurality of predetermined marks.

In some embodiments, the chatbot system employs the terminating mark to determine that the sentence and hence the input message is complete. Thereafter, a chatbot output message corresponding to the input is displayed for viewing. The chatbot system also contemporaneously removes the sentence from the chatbot dialog interface to prevent receipt of multiple sentences from the user. Thus, unlike conventional system wherein input messages with multiple sentences are received, the chatbot system generates a coherent and quality output before the user has an opportunity to enter simultaneous multiple input messages.

A further understanding of the nature and advantages of the present invention herein may be realized by reference to the remaining portions of the specifications and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

FIG. 1 illustrates a chatbot communication system according to an exemplary embodiment of the present invention.

FIG. 2 illustrates a chatbot dialog interface in accordance with an exemplary embodiment of the present invention.

FIG. 3 illustrates the chatbot dialog interface of FIG. 2 according to an exemplary embodiment of the present invention.

FIG. 4 illustrates the chatbot dialog interface of FIG. 2 according to an exemplary embodiment of the present invention.

FIG. 5 illustrates embedded code for installing a chatbot system onto a web site, in accordance with an exemplary embodiment of the present invention.

FIG. 6 is flowchart illustrating a method in accordance with an exemplary embodiment of the present invention.

FIG. 7A shows a typical computer such as would be operated by a user on the Internet.

FIG. 7B shows subsystems of the computer of FIG. 7A.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

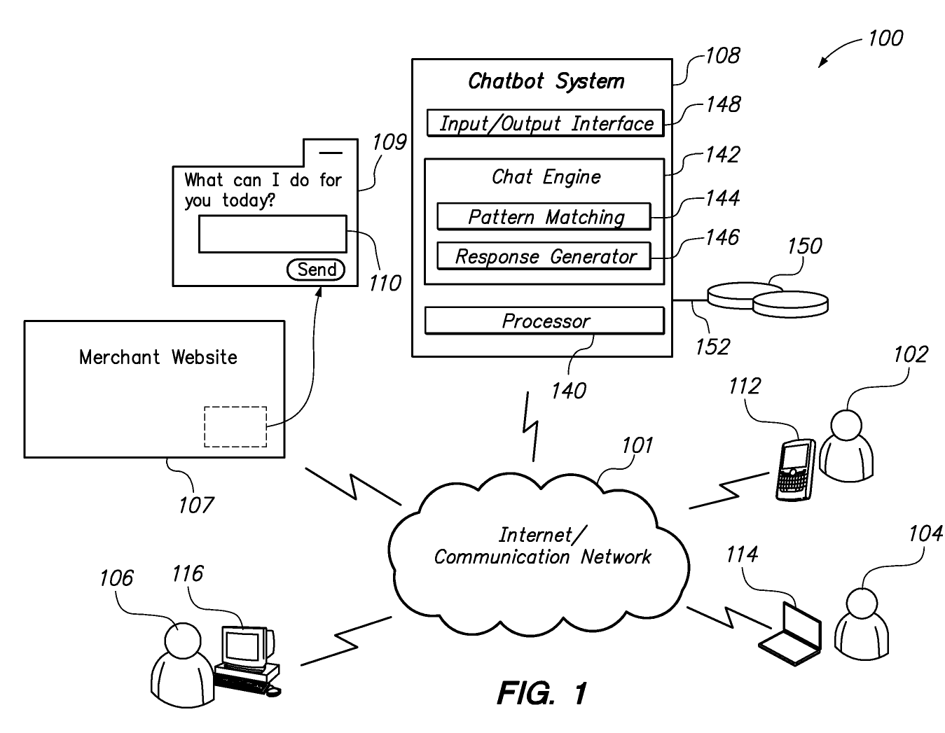

FIG. 1 illustrates chatbot communication system 100 according to an exemplary embodiment of the present invention.

In FIG. 1, chatbot communication system 100 comprises user 102 communicably coupled to chatbot system 108 via Internet 101. User 102 represents a customer visiting a website over Internet 101, and commencing a chat session with chatbot system 108.

Internet 101 represents any distributed network (wired, wireless or otherwise) for data transmission and receipt between/among two or more points. In some embodiments, chatbot system 108 includes a graphical image, including, without limitation, an avatar, a talking head, a text-to-speech engine, etc. Although not shown, chatbot system 108 might be installed on a stand-alone computer without need for a computer network.

As shown in FIG. 1, user 102 utilizes mobile device 112 to communicate with chatbot system 108. Mobile device 112 is a portable communication device such as a smart phone and the like. In one embodiment, the communication with chatbot system 108 can occur when user 102 is visiting one or more websites such as merchant website 107 that has chatbot dialog interface 116 of chatbot system 108 preinstalled on the website as further discussed below. User 102 essentially uses a browser (not shown) and chatbot dialog interface 116 to interact with chatbot system 108.

In FIG. 1, user 104 represents an additional customer. Many customers can concurrently communicate with chatbot system 108. Here, user 104 utilizes laptop computing device 114 for communicating with chatbot system 108 in a manner akin to user 102. For example, user 104 visiting merchant website 107 can also communicate with chatbot system 108 via chatbot dialog interface 116.

In FIG. 1, merchant 106 represents a merchant that operates merchant website 107. Merchant 106 installs chatbot dialog interface 116 of chatbot system 108 on its merchant website 107. Chatbot dialog interface 116 is a client extension of chatbot system 108. Thus, users can communicate with chatbot system 108 via chatbot dialog interface 116. Consequently, users visiting merchant website 107 can learn about products and/or services offered by merchant 106 by communicating with chatbot system 108 via chatbot dialog interface 116.

Here, merchant 106 provides initial training for chatbot system 108 by using a browser (not shown) on desktop computing device 115. Specifically, merchant 106 uses the browser to access and display chatbot dialog interface 116 to communicate with chatbot system 108. In essence, merchant 106 provides the message and theme for chatbot system 108 while users 102, 104 are the corresponding consumers.

Merchant 106 can train chatbot system 108 by entering input messages into dialog box 110 of chatbot dialog interface 116. Chatbot system 108 responds to an input message by displaying an output message via output display 109 above dialog box 110. As shown, an output message “What can I do for you today?” is displayed by output display 109. Note that this is a special output message, called an initial or opening message. Its corresponding “input message” is the user's action of browsing to a web page.

Chatbot messages are generated by chatbot system 108 by querying the input message from users in a knowledge base according to a certain set of rules. Merchant 106 trains chatbot system 108 to provide modified messages for a chat session by replacing chatbot system 108's initial chatbot messages with user-generated messages.

Chatbot system 108 includes a graphical image representing chatbot dialog interface 116, the graphical image including, without limitation, an avatar, a talking head, a text-to-speech engine, etc. In some embodiments, users 102, 104, 106 enter input messages to chatbot system 108 with a keyboard, mouse, and a visual recognition device.

The back and forth interaction between chatbot system 108 and users 102, 104 and 106 via chatbot dialog interface 116 allows knowledge database 150 to store and process myriad combinations of user-generated messages as context for additional future chatbot messages.

In FIG. 1, chatbot system 108 includes input/output interface 148 for entering and displaying messages to and from users 102, 104, 106. Chatbot system 108 also includes chat engine 142 that receives an input message from dialog box 110 and processes the input message by pairing or associating the input message with an appropriate chatbot message.

As shown in the embodiment of FIG. 1, chat engine 142 utilizes pattern matching engine 144 to recognize appropriate responses for input messages. In one embodiment, pattern matching engine 144 employs AIML (Artificial Intelligence Markup Language), which is an XML dialect for creating natural software agents. AIML comprises several elements. A first is category, which is a fundamental unit of knowledge. A category includes two or more elements namely pattern and template.

```
<category>
  <pattern>WHAT IS YOUR NAME</pattern>
  <template>My name is Eddy.</template>
</category>
```

When this category is loaded, an AIML receiving an input “What is your name” can respond with “My name is Eddy.” Here, a pattern is a string of characters that can match one or more user inputs. A pattern such as “What is your name” matches only one input, whether upper or lower case. However, patterns can also contain wildcards; thus, “what is your * “can match many inputs such as “what is your objective,” what is your address,” etc.

A template provides the response for a pattern. An example of a template is—My name is Eddy. A template can also use variables. A template may be as simple as some literal text, like “My name is <chatbot name=“name”/>,” which substitutes the chatbot's name into the sentence, or “You said you are <get name=“user-age”/> years of age,” in which the user's age is replaced in the sentence.

Text formatting, conditional response (if then/else), and random responses are elements of templates. Templates can also use the srai element to redirect to other pattern. As in this example where CDATA is used to avoid the need for XML escaping, synonymy may be implemented.

```
<category>
  <pattern>WHAT IS YOUR NAME</pattern>
  <template><![CDATA[My name is <chatbot
name=“name”/>.]]></template>
</category>
<category>
  <pattern>WHAT ARE YOU CALLED</pattern>
  <template>
  <srai>what is your name</srai>
  </template>
</category>
```

In the first category, the input “what is your name” receives the chatbot's name as a response. In the second category, the input “what are you called” is redirected to the category that matches the input “what is your name.” In essence, the two phrases are equivalent. Templates may include other content types that are processed by the chatbot user interface. As an example, a template may employ HTML tags for formatting. Clients not supporting HTML typically ignore the tag.

Those skilled in the art will recognize that other techniques that can either substitute or supplement pattern matching engine 144 can be employed. Pattern matching engine 144 then passes the chatbot message to response generator 146, which generates an appropriate response.

In FIG. 1, in one embodiment, knowledge database 150 may receive and store input messages 210 and user-generated messages including the context for such user-generated messages. The messages are received via chatbot dialog interfaces 116 displayed on mobile device 112, laptop computing device 114 or desktop computing device 115. Many components of chatbot system 108 have been omitted to avoid unnecessarily complicating the description of the invention. One skilled in the art will realize that chatbot system 108 may comprise more or less components as needed to implement the present invention.

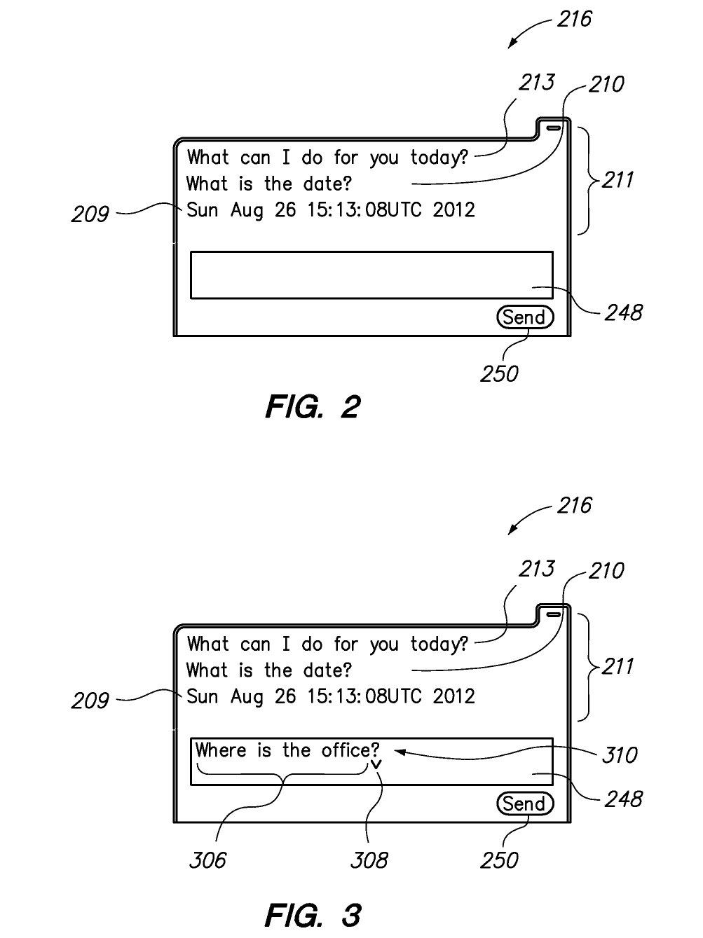

User-generated messages provide a context for subsequent chatbot messages of chatbot system 108, and for subsequent user input messages. In this manner, a new chatbot message is repetitively modified both prior to and during a chat session by entering a plurality of user-generated messages and training chatbot system 108 by preceding and/or following user-generated messages with unique identifiers (e.g., 202 of FIG. 2).

Briefly, in operation, merchant 106 trains chatbot system 108 to provide modified chatbot messages that are displayed by output display 109 of chatbot dialog interface 116. Merchant 106 utilizes merchant website 107 to install and utilize chatbot system 108. Merchant website 107 can provides a plethora of information to numerous customers simultaneously. Merchant website 107 operatively couples to Internet 101 via local network line 128.

Merchant 106 trains chatbot system 108 to provide modified chatbot messages 109 during a chat session. Thus, for example, merchant 106 might wish to teach chatbot system 108 to respond to address inquiries received from users of merchant website 107. User/merchant 106 begins by entering “Where are your offices?” into chatbot dialog interface 116.

In response, chatbot system 108 might generate a response such as “Please check our website, thank you.” Merchant 106 being dissatisfied with this message may wish to replace this chatbot response with the merchant's business address. Generally, merchant 106 can then enter “100 Main Street” into chatbot dialog interface 116. Thereafter, when the customer enters an input message “Where is your business located?,” chatbot system 108 replies, “100 Main Street”. Those skilled in the art will recognize that user-generated message (provided by merchant 106) is more robust and descriptive than the initial chatbot message.

FIG. 2 illustrates chatbot dialog interface 216 of chatbot system 108 (FIG. 1) in accordance with an exemplary embodiment of the present invention.

In FIG. 2, chatbot dialog interface 116 comprises a visual graphic interface having dialog box 248 and output display 211. User 102 (FIG. 1) can enter input messages via dialog box 248. In response, chatbot system 108 generates output messages responding to the input messages. As implied by its name, output display 211 can display such output messages from chatbot system 108.

As can be seen in FIG. 2, a chat session has been initiated between user 102 and chatbot system 108. Specifically, a special initial message “What can I do for you today?” 213 is displayed by chatbot system 108. This special initial message 213 prompts user 102 for an input message.

Responsive to prompt message “What can I do for you today?” 213, user 102 enters an input message “What is the date?” 210 into dialog box 248 and, in one embodiment, clicks send button 250 to submit the input message. Note that in other embodiments further discussed below, user 102 may not get a chance to select send button 250 as chatbot system 108 automatically responds immediately after input message “What is the date?” 210 is received.

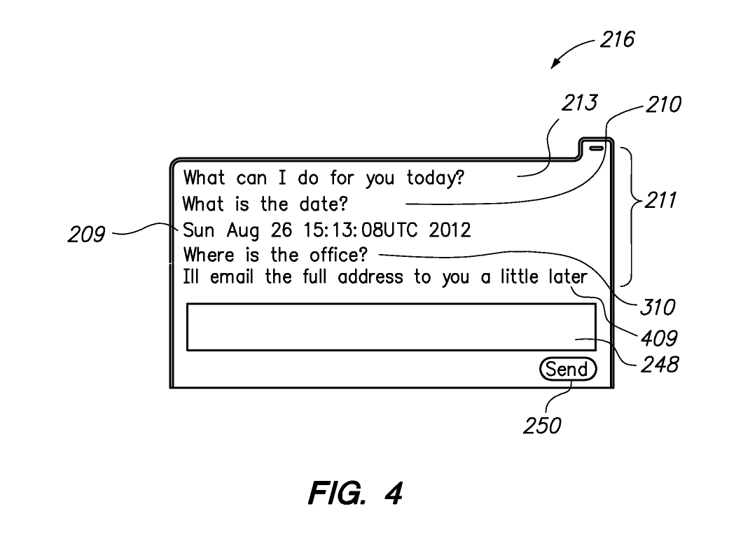

As shown, chatbot system 108 responds by displaying output message “Sun Aug 26 15:13:08 UTC 2012” 209. The operation for entering an additional input message will now be described with reference to FIG. 3, below.

FIG. 3 illustrates chatbot dialog interface 216 of FIG. 2 according to an exemplary embodiment of the present invention.

In FIG. 3, as can be seen, user 102 is entering input message 310 in the chatbot dialog interface 216. In this manner, user 102 can interact with chatbot system 108. Here, although user 102 can enter input message 310, additional input messages may not be entered along with input message 310.

Thus, an advantage of the present invention is that user 102 cannot simultaneously enter additional sentences along with input message 310. In this manner, and unlike conventional systems and methods, chatbot system 108 can provide a coherent and quality response to each user input message separately, thus ultimately enhancing user 102's chatbot experience.

As is often the case with chatbot users, user 102 might wish to enter multiple messages with input message 310. The present invention, in one embodiment, begins by monitoring the initial message entered by user 102. Here, this initial message is input message 310. As user 102 enters input message 310, chatbot system 108 monitors each text to determine whether a complete sentence has been formed.

A complete sentence might be based on predetermined conditions or rules as to what constitutes a sentence. Such rules might vary depending upon the grammatical rules of the language in use. In one embodiment, based on English, a complete sentence or input message 310 can be defined as having a grammatical unit 306 and a terminating mark 308.

Grammatical unit 306 might be one or more words that express an independent request, statement, exclamation, command, etc., and that typically has a subject as well as a predicate. Those skilled in the art will recognize that grammatical unit 306 may also include a clause, phrase, etc. that form a sentence. As an example, a grammatical unit might be “Where is your office”.

Terminating mark 308, in one embodiment, is a punctuation mark for identifying the end of an inquiry, thought, expression, statement, etc. following grammatical unit 306. Suitable terminating marks 308 include, without limitation, a period, an exclamation point, a question mark, a quotation mark following one of the aforementioned marks, etc.

In another embodiment, terminating mark 308 includes both the punctuation mark followed by a space. Thus, terminating mark 308 might be a period and a space, an exclamation point and a space, a question mark followed by a space, or other suitable marks followed by a space. These terminating marks are predetermined and preselected and may be stored ahead of time by chatbot system 108.

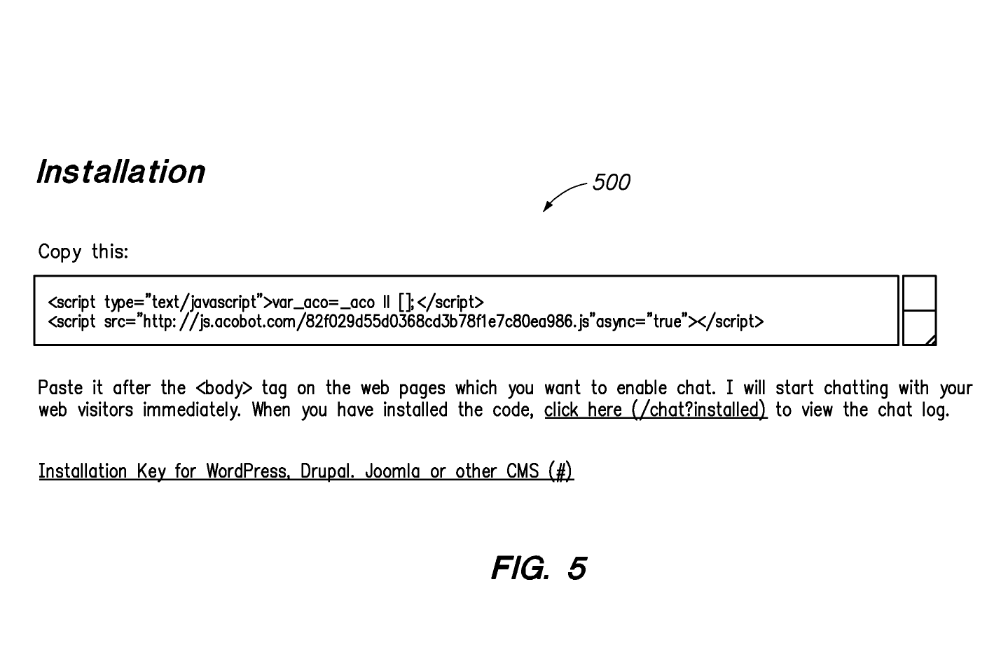

Thus, as input message “Where is your office?” 310 is entered, the present invention identifies each character of grammatical unit 306 “Where is your office” and then detects terminating mark 308 namely question mark “?”. Upon detecting terminating mark “?” 308, chatbot system 108 establishes that the sentence is complete, clears dialog box 248 and then immediately responds to input message 310 before user 102 has an opportunity to enter additional input messages with input message 310, as further described with reference to FIG. 4, below. In essence, chatbot system 108 may respond akin to when send button 250 (or an enter button) is selected.

Here, note that the position of terminating mark 308 might depend on the language in use. For example, in the English language, terminating mark 308 ends a sentence to the right of grammatical unit 306 as in “Where is your office?”

However, in other languages, the terminating mark 308 might be located on the left of grammatical unit 306. For example, in Arabic, “Where is your office?” translates into “ [symbol] .” As can be seen, the terminating mark “?” is to the left of grammatical unit 306. As another example, in Spanish, terminating mark 308 such as a question mark and an exclamation mark are in pair. One is placed at the beginning of the sentence and another at the end.

In another embodiment, chatbot system 108 responds to input message 310 after detecting terminating mark 308 followed by a space. When chatbot system 108 detects the space following the question mark, again it immediately responds before user 102 can enter additional grammatical units and without user 102 selecting send button 250.

In this manner, chatbot system 108 of the present invention processes identifiable single input messages that have corresponding responses in the chatbot knowledge database. And as chatbot system 108 doesn't have to assembly multiple outputs into one output message, the inconsistency or conflicts among the replies are safely avoided.

Unlike conventional systems, users can type multiple sentences to form the input message even with a character limit. And unlike conventional systems that receive multiple sentences in an input message and provide a response to the entire input or alternatively respond to each sentence separately and then reassemble an output message based on the responses, the present invention need only process a single input message to provide quality output messages and enhance user experience.

The output message for responding to input message 310 will now be described with reference to FIG. 4.

FIG. 4 illustrates chatbot dialog interface 216 of FIG. 2 according to an exemplary embodiment of the present invention.

In FIG. 4, specifically, input message “Where is your office?” 310 has been entered, dialog box 248 is cleared, and output message “I'll email the full address to you a little later” 409 responsive to input message 310 is displayed. As discussed in FIG. 3, chatbot system 108 establishes that input message 310 is complete by identifying terminating mark 308 following grammatical unit 306. Those skilled in the art will recognize that the first terminating mark 308 that appears marks the end of grammatical unit 306.

After identifying a complete input message 310, chatbot system 108 contemporaneously enters the message and removes this input message 310 from dialog box 248. In this manner, additional sentences and input message 310 cannot be entered into dialog box 248, thus preventing user 102 from entering multiple input messages that cannot be responded to by chatbot system 108. Here, chatbot system 108 can then respond to the single input message 310.

Note however that although dialog box 248 is cleared, user 102 may enter a new message which is responded to without user 102 selecting send button 250. The chat communication continues as user 102 enters input messages and chatbot system 108 responds with corresponding output messages whenever a complete sentence is identified.

In FIG. 4, as noted, upon identifying a complete sentence, chatbot system contemporaneously enters input message 310, clears dialog box 248, and displays this input message 310 in output display 211 for viewing. Input message 310 is entered without waiting for user 102 to select send button 250 (or enter button). In essence, once a complete sentence is identified, input message 310 is entered just as if send button 250 is selected. That is, chatbot system 108 simulates receipt of an enter command when a complete sentence is identified.

In an alternative embodiment, when send button 250 (or enter button) is actually selected, chatbot system 108 determines whether input message 310 includes a plurality of sentences. Those skilled in the art will recognize that a copy and paste function from a word processor may generate such a plurality of sentences.

If input message 310 comprises a plurality of sentences, chatbot system 108 does not enter the multiple messages at once. Rather, chatbot system 108 identifies and responds to the first complete sentence.

Once identified, that first complete sentence is removed from dialog box 248, displayed in output display 211 and then entered into the system to receive a corresponding output message. Meanwhile, the remaining multiple sentences are left in dialog box 248. User 102 can then again repeat this process by selecting send button 250 to send the next identified complete sentence or alternatively delete/edit the remaining sentences.

In yet another alternative embodiment, input message 310 may include a plurality of sentences. Chatbot system 108 identifies and responds to a first of the plurality of the sentences from dialog box 112, and then removes all of the sentences from dialog box 248.

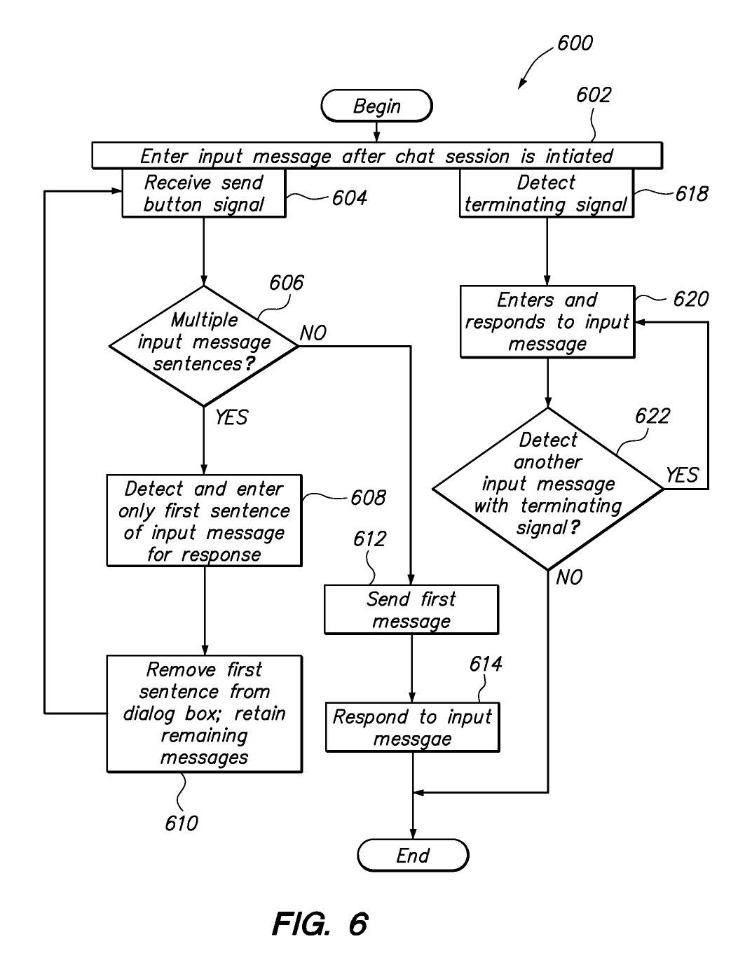

FIG. 5 illustrates embedded code 400 for installing chatbot system 108 onto a web site, in accordance with an exemplary embodiment of the present invention.

In FIG. 5, specifically, embedded code 400 is embedded into a desired webpage to install chatbot system 108, thereafter, chat sessions between merchant 106 and chatbot system 108 can occur. Those skilled in the art will recognize that the installation of chatbot system 108 and user-aided learning chatbot method 500 is efficacious for facilitated installation by a user. For example, merchant 106 might use without limitation the following:

Copy this:
<script type=“text/javascript”>var _aco = _aco || [ ]:</script>
<script src=“http://js.acobot.com/82f029d55d0368cd3b78f1e7c80ea986.js”
async=“true”></script>
Paste it after the <body> tag on the web pages which you want to enable
chat. I will start chatting with your web visitors immediately. When you
have installed the code, click here (/chat?installed) to view the chat log.
Installation Key for WordPress, Drupal, Joomla or other CMS (#)

Here, the HTML script tag is used enable a JavaScript for client side scripting. Once installation is complete, merchant 106 can continue training chatbot system 108 to provide modified messages for each additional input message. Note that although not discussed, in one embodiment chatbot system 108 might be based on a Markov chain.

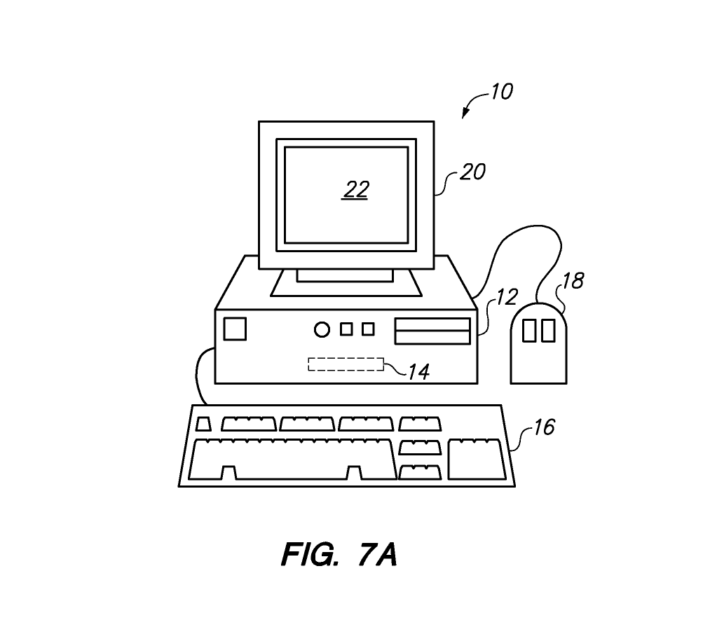

FIG. 6 is flowchart illustrating method 600 in accordance with an exemplary embodiment of the present invention.

In FIG. 6, method 600 might be operable by chatbot system 108 of FIG. 1. Here, method 600 processes and responds to input messages received from user 102.

At block 602, a chat session is initiated between user 102 and chatbot system 108. This chat session is initiated when user 102 enters input message 210 (FIG. 2) or input message 310 (FIG. 3) via dialog box 248 (FIG. 3). Input message 310 might be a sentence such as an inquiry, comment, or opinion in the form of one or more grammatical units. Input message 310 may or may not include multiple sentences.

Execution of method 600 proceeds to either block 604 or block 618 depending upon whether a send signal (or enter button) is selected by user 102 following entry of the message. If chatbot system 108 detects selection of send button 250 (FIG. 3) after input message 310, execution proceeds to block 604. Else, if a terminating mark is detected, execution proceeds to block 618. In one embodiment, each time user 102 hits a key (or types a character), chatbot system 108 checks to determine, if the typed text ends with a terminating mark. If yes, execution proceeds to next block. If no, the system does nothing unless an enter button is received.

At block 604, chatbot system 108 detects selection of send button 250 after entry of input message 310. Thus, execution proceeds to block 606.

At decision block 606, the system determines whether input message 310 has multiple sentences. User 102 can generate multiple sentences by using a copy and paste function from a word processor, for example. If input message 310 includes multiple sentences, execution proceeds to block 608. Else execution proceeds to block 612.

At block 608, it has been determined that input message 310 includes multiple sentences. Here, unlike conventional systems, chatbot system 108 does not enter the entirety of sentences in input message 310. Rather, chatbot system 108 detects and enters only the first sentence of input message 310.

In this manner, the first sentence can be properly paired with corresponding knowledge entries in the system database to receive a quality and coherent response to that first sentence. Thus, upon receiving the first sentence, chatbot system 108 generates an appropriate output response that is displayed for viewing by user 102. Execution of method 600 then proceeds to block 610.

At block 610, chatbot system 108 removes the first sentence from dialog box 248; and retains the remaining messages thereof. Execution then proceeds back to blocks 604 and 606 previously described, until input message 310 has only a single sentence. At that point, execution proceeds from decision block 606 to block 612.

At block 612, input message 310 has only a single sentence. Thus, chatbot system 108 enters the single message for an output response.

At block 614, chatbot system 108 displays a corresponding output message for input message 310 with the single sentence, after which the process ends at end block 615.

On the other hand, if a send signal (or enter button) is not selected by user 102 following entry of input message 310, and rather a terminating mark is detected, execution proceeds to block 618.

At block 618, chatbot system 108 detects a terminating mark following entry of input message 310 to establish that input message 310 now comprises a complete sentence. Chatbot system 108 has predefined conditions as to what constitutes a complete sentence. The criteria for a sentence can vary based on languages.

Taking English for instance, a sentence can be identified by the following rule: A sentence ends with a terminating mark such as any one of the following punctuation marks: 1) full stop or period; 2) question mark; 3) exclamation mark 4) one of the above followed by a quotation mark (“).

In one embodiment, in Latin languages like English, a list of “exceptions” where termination marks are inapplicable can be maintained. As an example, termination marks might be inapplicable for abbreviations with stop points, periods or full stops. For example, termination marks are inapplicable to the following abbreviations: “Mr.” and “i.e.” and “e.g.” If a string matching any of the exceptions is entered, chatbot system 108 simply ignores the terminating mark. Else, once any one of the aforementioned terminating marks is detected, execution passes to block 620.

At block 620, chatbot system 108 upon detecting the termination mark simulates the behavior of user 102 selecting an enter or send button. Chatbot system 108 thus enters input message 310, removes the sentence from dialog box 248, displays it to user 102 and generates a corresponding output message for viewing by user 102. Execution then passes to decision block 622.

At decision block 622, chatbot system 108 continuously monitors user 102's input to determine if another terminating mark has been entered. If yes, execution proceeds to block 620, where a corresponding output message is generated. Else, execution proceeds to end block 615.

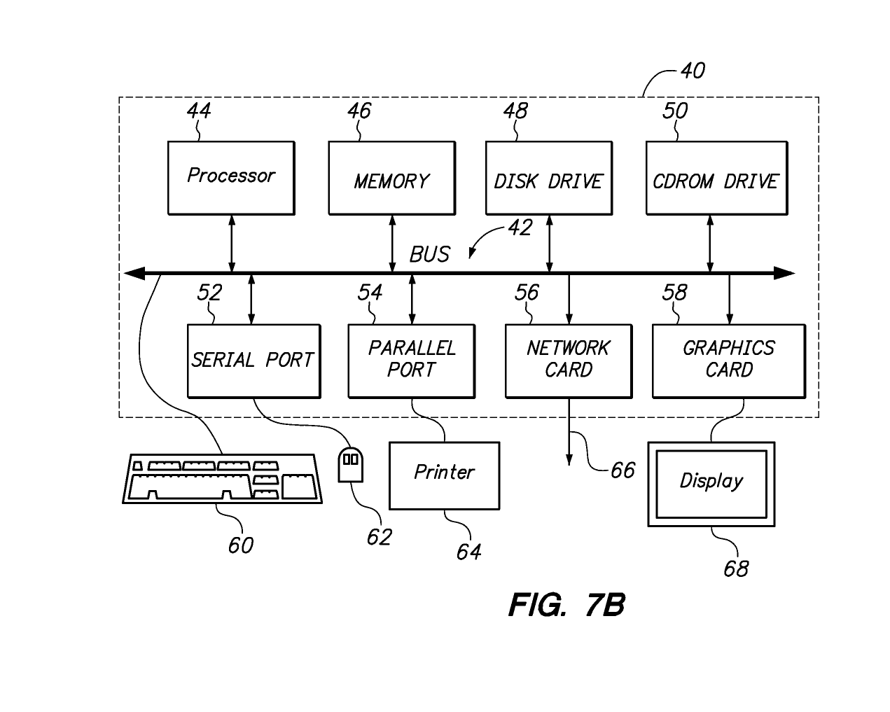

FIG. 7A shows a typical computer 10 such as would be operated by a user on the Internet. Computer 10 includes a cabinet 12 housing familiar computer components such as a processor, memory, disk drive, Compact Digital Read-Only Memory (CDROM), etc. (not shown). User input devices include keyboard 16 and mouse 18. Output devices include display 20 having a display screen 22. Naturally, many other configurations of a computer system are possible. Some computer systems may other components in addition to those shown in FIG. 7A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 7A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 7A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 7B shows subsystems of the computer of FIG. 7A. In FIG. 7B, subsystems within box 40 are internal to, for example, the cabinet 12 of FIG. 7A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 7B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method, operable by a chatbot, for responding to an input message, wherein the chatbot includes a processor, an interactive dialog interface, and a knowledge database, the method comprising:
receiving, during a chat session, the input message having a sentence to which a user desires a response, wherein the sentence includes a terminating mark configurable to prompt the chatbot to respond to the input message without the chatbot receiving an enter or submit indication from a user;
using the terminating mark to determine that the input message is complete even if said user wishes to enter additional sentences; and
responding to the input message determined to be complete by displaying via the interactive dialog interface an output message responsive to the sentence and contemporaneously removing the sentence from the interactive dialog interface to prevent receipt of additional sentences following the input message.

2. The method of claim 1, wherein the terminating mark is a period followed by a space.

3. The method of claim 1, wherein the terminating mark is a period.

4. The method of claim 1, wherein the terminating mark is a question mark followed by a space.

5. The method of claim 1, wherein the terminating mark is a question mark.

6. The method of claim 1, wherein the terminating mark is an exclamation mark followed by a space.

7. The method of claim 1, wherein the terminating mark is one of a period, a question mark and an exclamation mark followed by a quotation mark.

8. The method of claim 1, wherein the terminating mark is an exclamation mark.

9. A method, operable by a chatbot, for responding to an input message that includes a sentence, wherein the chatbot includes a processor, an interactive dialog interface, and a knowledge database, the method comprising:
storing a plurality of predetermined punctuation marks for identifying when a sentence is complete;
receiving, during a chat session, the input message having a sentence to which a user desires a response, wherein the sentence is followed by one of said plurality of predetermined punctuation marks;
using said one of said plurality of predetermined punctuation marks to determine that the sentence is complete; and
generating an output message corresponding to the input message upon determining that said input message is complete.

10. The method of claim 9, wherein said plurality of predetermined punctuation marks are: period or full stop, an exclamation mark and a question mark.

11. The method of claim 9, the output message is generated without receiving an enter or submit signal from a user.

12. A system, operable by a chatbot, for responding to an input message, wherein the chatbot includes a processor, an interactive dialog interface, and a knowledge database, the system comprising:
one or more lines of code instruction that store a plurality of predetermined punctuation marks for identifying when a sentence is complete;
one or more lines of code instruction that receive during a chat session, the input message having a sentence to which a user desires a response, wherein the sentence is followed by one of said plurality of predetermined punctuation marks;
one or more lines of code instruction that use said one of said plurality of predetermined punctuation marks to determine that the sentence is complete; and
one or more lines of code instruction that generate an output message corresponding to the input message upon determining that said input message is complete.

13. The system of claim 12, wherein said plurality of predetermined punctuation marks are: period or full stop, an exclamation mark and a question mark.
